(19) United States
(12) Patent Application Publication
(10) Pub. No.: US 2014/0032899 A1
(43) Pub. Date: Jan. 30, 2014

(54) Method and system for secure form delivery

(71) Applicants: Marc T. Kaufman, Woodside, CA (US); Genevieve Laroche, San Jose, CA (US); Roberto Perelman, Sunnyvale, CA (US); Joseph D. Steele, Danville, CA (US)

(72) Inventors: Marc T. Kaufman, Woodside, CA (US); Genevieve Laroche, San Jose, CA (US); Roberto Perelman, Sunnyvale, CA (US); Joseph D. Steele, Danville, CA (US)

(73) Assignee: Adobe Systems Incorporated

(21) Appl. No.: 11/594,467

(22) Filed: Nov. 8, 2006

(51) Int. Cl. G06F 21/62

(52) U.S. Cl. CPC G06F 21/6209
USPC 713/165

(57) ABSTRACT

A system, for secure form delivery, may include a detector to detect a request to submit an electronic form that includes associated application data; an encryption module to respond to the request to submit the electronic form by automatically accessing an encryption key, determining destination information, and encrypting the associated application data, utilizing the encryption key; and a submit module to submit the electronic form to a destination, utilizing the destination information.

### TECHNICAL FIELD

This application relates to a method and system for secure form delivery.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Portable Document Format (PDF) is one example of a standard for a secure and reliable distribution and exchange of electronic documents and forms, e.g., via electronic mail (email) systems. Some existing email systems do not provide sufficient security features, in the sense that anyone who intercepts the email may be able to read it. While some existing systems provide secure forms of email, such systems may require that a user, who wishes to utilize the secure email capability, manages the encryption keys needed to send and receive secure email. Both the sender and the recipient may be required to agree in advance to exchange secure email, and both must actively manage the security functionality.

For example, an originator of an electronic form may send out the electronic form to a recipient and request the recipient to fill out the electronic form. The originator may also send to the recipient a public key and the instructions on what operations may be performed in order to encrypt the filled out electronic form prior to submitting it back to the originator. In this scenario, the originator may have to rely on the recipient's being inclined to perform the encryption operations as described in the instructions, and on the recipient's being capable of following the encryption instructions accurately.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing an architecture within which a method and system for secure form delivery may be implemented, in accordance with an example embodiment;

FIG. 2 is a block diagram illustrating a system, in accordance with an example embodiment, to utilize automatic encryption functionality;

FIG. 3 is a flow chart illustrating a method to utilize automatic encryption functionality, in accordance with an example embodiment;

FIG. 4 is a block diagram illustrating a system, in accordance with an example embodiment, to automatically encrypt application data associated with an electronic form;

FIG. 5 is a flow chart illustrating a method to automatically encrypt application data associated with an electronic form, in accordance with an example embodiment;

FIG. 6 illustrates a diagrammatic representation of a machine in the example form of a computer system within which a set of instructions, for causing the machine to perform any one or more of the methodologies discussed herein, may be executed.

### DETAILED DESCRIPTION

A method and system are described to provide secure delivery of electronic form data. In an example embodiment, an encryption key may be embedded in an electronic form. When a user fills out the electronic form in order to provide electronic form data to a forms collector, no special actions are required to be performed by the user in order to encrypt the electronic form data prior to submitting the filled out form. It will be noted, that, for the purposes of this description, the terms “form” and “electronic form” may be used interchangeably.

An electronic form may, in one example embodiment, embody a complex “application packaged as a document” that may utilize a template-based grammar where the template associated with an electronic form defines presentation, calculations and interaction rules, while the content of the electronic form comprises the application data of a user. One example of an architecture that distinguishes between an electronic form template and electronic form content is the eXtensible Markup Language (XML) Forms Architecture (XFA). XFA provides a template-based grammar and a set of processing rules that may allow the implementing of interactive electronic forms. A template-based grammar may define fields, in which a user provides data, thereby permitting the user to interact with the electronic form by supplying values and selecting options.

An electronic form may be useful for collecting information from a group of people in an organized manner. For example, a blank electronic form that does not have any associated content (an original form) may be distributed to a number of recipients with a request to fill out the form and to return the filled out form to a particular destination designated as a forms collector. A person or a process that initiates a workflow of a form, e.g., by distributing the form to one or more recipients, may be referred to as an originator. It will be noted that, in one example embodiment, the originator and the forms collector may be the same person or may be represented by the same destination. The original form may include a control, e.g., a control button, to permit a user to send the filled out form to the forms collector destination simply by pressing the control button (a so-called submit button).

In one example embodiment, the original form that is designed to be used for collecting data from a recipient may be configured to include a mechanism for encrypting the collected data, an encryption key, and a built-in instruction to trigger an automatic encryption process in response to a predetermined event. A predetermined event may be, for example, an activation of the submit button on the form by a user or a request to save the form by a user. The encryption key, in one example embodiment, may be the public key from a key pair associated with the forms collector. Because the private key from the key pair may be under exclusive control of the forms collector, any data encrypted with the public key embedded in the original form would only be accessible by the holder of the corresponding private key, the forms collector in this case.

The original form, in one example embodiment, includes a destination address associated with the forms collector. The destination address is, for example, an electronic mail (email) address or a web site designation. The destination address may be incorporated into the functionality of a submit button mentioned above. In effect, a user (e.g., a recipient of the original form) may only be required to click on the submit button in order to send the filled out form to the forms collector, while the form data is being encrypted prior to being transmitted over a network in a process that may be transparent to the user.

In some embodiments, a user may send the filled-out form to the forms collector by utilizing an email client and attaching the filled-out form to an email message. In this embodiment, the original form provided to the recipient may not include a submit button or a destination address. The automatic encryption process may be triggered by a save operation initiated by the recipient.

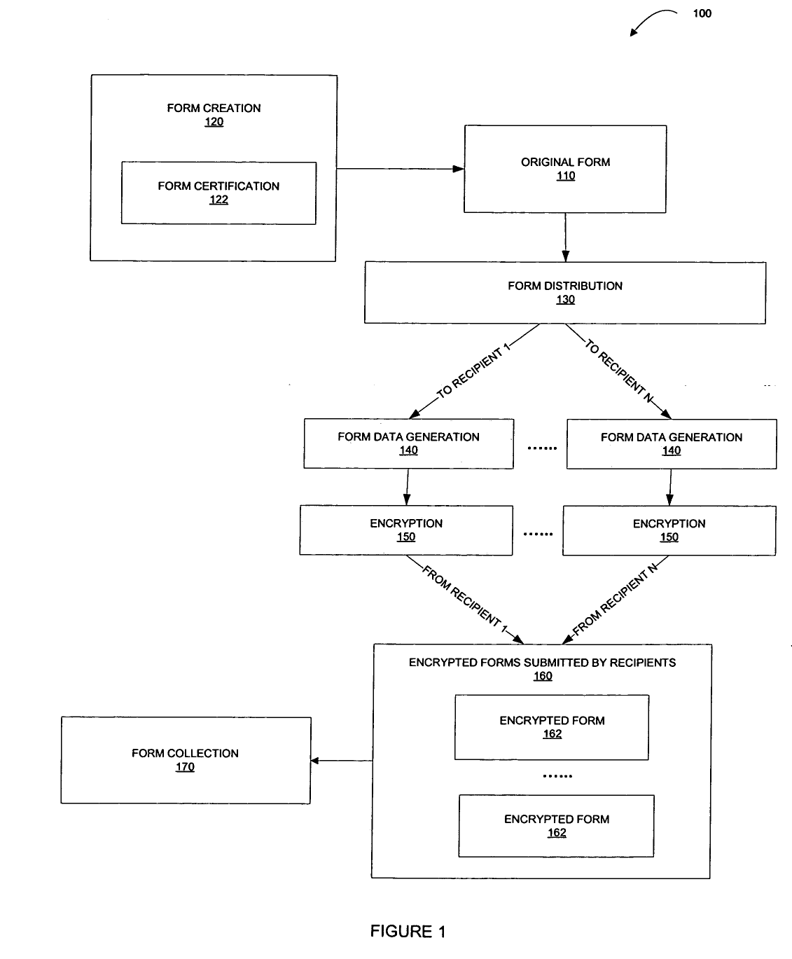

In one example embodiment, in order to enhance security of the form distribution process, the electronic form that is being delivered to one or more recipients may be a certified form. Certification of an electronic document typically indicates that the document has been preserved to comply with the author's intent. In an architecture that distinguishes between an electronic form template and electronic form content, a certificate (e.g., a certifying signature) may be associated with the form's template, but not necessarily with any of the form field data. For example, an originator may certify a template and distribute an associated certified electronic form, but nonetheless permit recipients to fill out the form fields with data without invalidating the certificate. An example architecture of a system for secure form delivery is illustrated in FIG. 1.

FIG. 1 shows an example architecture 100, within which a method and system for secure form delivery may be implemented. In the context of the architecture 100 an original electronic form 110 created by form creation logic 120 is distributed, utilizing distribution logic 130, to a group of recipients, e.g., to recipients 1 through N. The original form may be certified, e.g., utilizing certification logic 122, prior to the distribution, in order to provide an assurance to the recipient that the original form 110 has not been manipulated in a manner that is contrary to the intent of the author of the form.

A recipient, e.g., recipient 1, may load the original form utilizing an appropriate user application, such as Adobe® Acrobat®. The recipient may then fill out the original form utilizing form data generation operations 140. When the recipient finishes filling out the form, the recipient may initiate a submit request to return the filled out form back to the originator or to some other predetermined forms collection destination. A submit request from the recipient may automatically trigger an encryption process 150. The resulting encrypted form 160 may then be delivered to a forms collection destination 170. The data generation operations 140 and the encryption process 150 may be performed for all recipients 1 through N, such that a plurality of the encrypted forms 160 may be delivered to the forms collection destination 170.

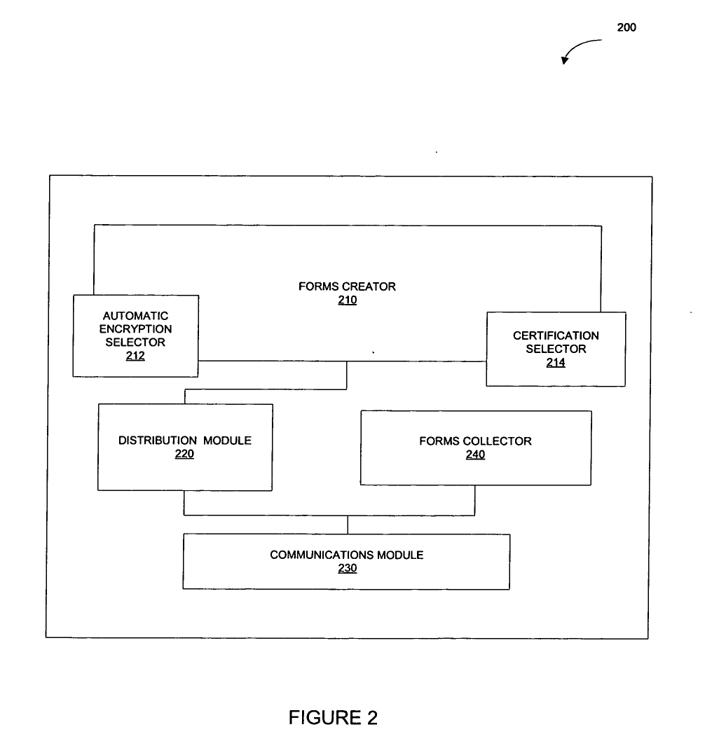

In one example embodiment, an encrypted form 160 may be submitted to the forms collection destination 170 as an encrypted attachment to an email message. An example system to utilize automatic encryption functionality is described below with reference to FIG. 2.

FIG. 2 shows a block diagram illustrating an example system 200. The system 200 may include a forms creator 210, a distribution module 220, a communications module 230, and a forms collector 240.

The forms creator 210, in one example embodiment, may be configured to permit a user to generate an electronic form having automatic encryption capability. A user (e.g., an originator) may choose to add the automatic encryption capability to an electronic form utilizing an automatic encryption selector 212. The distribution module 220 may be configured to provide an electronic form generated by the forms creator 210, e.g., an electronic form in Portable Document Format (PDF), to one or more recipients. A certification selector 214 may be configured to certify the electronic form if the originator chooses to provide an assurance to recipients that the electronic form that they received is free from tampering. The certification selector 214 may be configured to certify any created electronic form automatically.

It will be noted that, in one example embodiment, the automatic encryption selector 212 and the certification selector 214 may be included as part of the forms creator 210. In other embodiments, either one or both of the automatic encryption selector 212 and the certification selector 214 may be configured as modules that are separate from the forms creator 210. In yet another embodiment, the functionality of either one or both of the automatic encryption selector 212 and the certification selector 214 may be incorporated in the distribution module 220, such that the automatic encryption option and the certification option may be selected by the originator at distribution time.

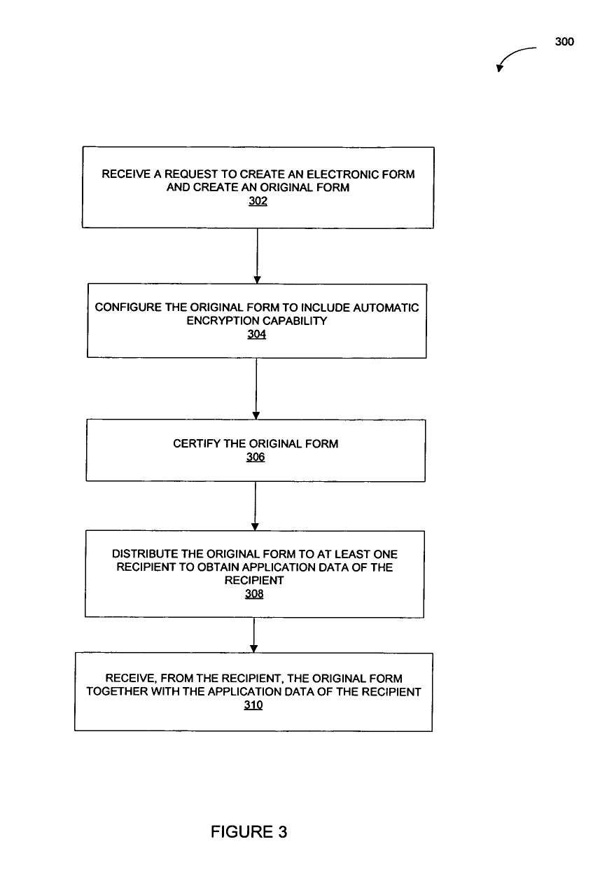

The distribution module 220 may be configured to cooperate with the communications module 230, which, in turn, may be configured to send an electronic form designated for distribution to a predetermined group of recipients. When a recipient returns a filled out form, the filled out form may be received and further processed by the forms collector 240 via the communications module 230. Various operations performed by the system 200, according to an example embodiment, may be described with reference to FIG. 3.

FIG. 3 is a flow chart illustrating a method 300 to utilize automatic encryption functionality, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. It will be noted, that, in an example embodiment, the processing logic may reside in any of the modules shown in FIG. 2.

As shown in FIG. 3, the method 300 commences with the forms creator 210 of FIG. 2 receiving a request, at operation 302, to create an electronic form. The forms creator 210 creates the electronic form in response to the request. The only data in the newly created electronic form, which may be termed an original form, may be default values defined in the template.

At operation 304, the automatic encryption selector 212 may configure the original form to include automatic encryption functionality. The automatic encryption selector 212 may include an encryption key, e.g., a public key associated with the forms collector 240 of FIG. 2, into the template definition of the original form. In one example embodiment, the template definition of the original form may include additional security data, such as, for example, a certificate associated with the author of the original form.

The automatic encryption selector 212 may provide a destination address with the template definition of the original form. The destination address may indicate where the electronic form is to be submitted by a recipient. The destination address may be represented, for example, by an email address of a network user or a web site destination. If the destination address is an email address of a network user, the template definition of the original form may also include a subject line and a body text for an email message that would include a submission of the filled out original form.

At operation 306, the certification selector 214 certifies the original form. The distribution module 220 distributes the certified original form to at least one recipient in order to obtain the recipient's data at operation 308. The recipient's data associated with the original form, e.g., by virtue of having been entered into the data fields of the original form may be termed the application data of the recipient.

The forms collector 240 receives the original form together with the application data of the recipient at operation 310. The application data of the recipient may be encrypted utilizing the automatic encryption mechanism that has been incorporated into the original form via the automatic encryption selector 212.

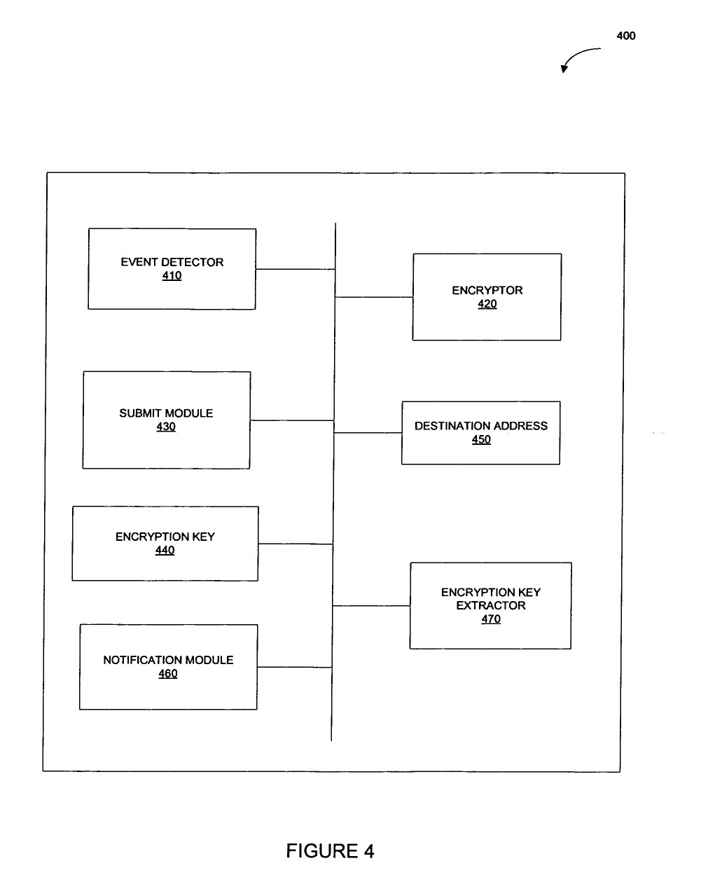

The example method 300 may be utilized advantageously, for example, in a scenario where data is being sent over the network. In the context of magazine subscriptions, for example, a person who fills out the subscription form may enter her credit card number along with other information required to subscribe. The subscription request with the credit card number that is submitted electronically via a system with automatic encryption functionality may have all user data, including the credit card number, encrypted and therefore secure from any misuse by malicious interceptors. An example system corresponding to an electronic form configured to include automatic encryption functionality is discussed below with reference to FIG. 4.

FIG. 4 is a block diagram illustrating an example system 400 to automatically encrypt application data associated with an electronic form. The system 400, in one example embodiment, comprises an event detector 410 and an encryptor 420. The event detector 410 may be configured to detect an event that has been designated as an event that may trigger encryption operations applied to recipient's application data associated with the electronic form data. The encryption operations may be performed by the encryptor 420. It will be noted that the system 400 may be hosted on a recipient's machine (e.g., associated with an application that may be used by a recipient to fill out an electronic form). In some example embodiments, the system 400 may reside on a system that is remote with respect to a recipient.

An event that may trigger encryption operations may be, for example, a request from a recipient to submit the filled-out original form to a forms collector. In one embodiment, the encryptor 420 may perform the encryption operations in response to the event detector 410 detecting a request from a recipient to save the filled-out form. The encryptor 420 may be configured to access an encryption key 440 that may be embedded in the original electronic form that may be represented by the system 400. It will be noted that, in some example embodiments, an original form corresponding to the system 400 may include further embedded security information, in addition to the encryption key 440. Such additional information may include, for example, information regarding the source of the original form.

The encryptor 420 may utilize the embedded encryption key 440 to encrypt the filled-out form. It will be noted that the encrypting of the filled out form may include encrypting the content of the form, e.g., encrypting the data entered into the form fields by the recipient.

The system 400 may further include a submit module 430. The submit module 430 may be configured to assess a destination address 450 that may be embedded in the in the original form represented by the system 400. The submit module 430 may then send the encrypted filled out form to the form collection destination 170 of FIG. 1, utilizing the destination address 450. The destination address 450 may be, in one embodiment an email address of the originator of the electronic form or an email address of an email address of an electronic mailbox to collect filled out forms from recipients. In some embodiments, where the filled out forms from recipients may be collected via a web site, the destination address 450 may be a designation of a web site.

After the submit module 430 submits the encrypted filled out form to the form collection 170 destination, the system 400 may pass the control to a notification module 460. The notification module 460, in one example embodiment, may be configured to notify the recipient that a secure version of the filled out form has been sent to the form collection destination 170.

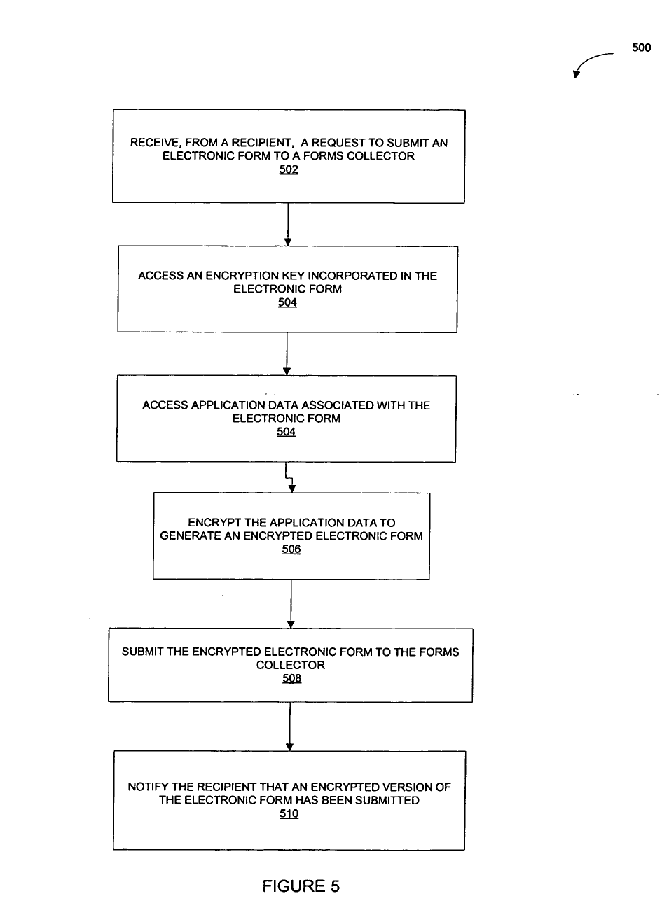

The system 400 may further include an encryption key extractor 470. The encryption key extractor 470 may be configured to extract the encryption key 440 embedded in the electronic form and to save the extracted encryption key 440. The saved encryption key 440 may then be used by the recipient to encrypt other communications to the form collection destination 170. Various operations performed by the system 400, according to an example embodiment, may be described with reference to FIG. 5.

FIG. 5 is a flow chart illustrating an example method 500 to automatically encrypt application data associated with an electronic form. The method 500 may be performed by processing logic that may comprise hardware (e.g., dedicated logic, programmable logic, microcode, etc.), software (such as run on a general purpose computer system or a dedicated machine), or a combination of both. It will be noted, that, in an example embodiment, the processing logic may reside in any of the modules shown in FIG. 4.

As shown in FIG. 5, the method 500 commences with the submit module 430 of FIG. 4 receiving a request, at operation 502, to submit an electronic form to the form collection destination 170. In response to the submit request, the encryptor 420 accesses an encryption key embedded in the electronic form at operation 504, accesses form data at operation 506, and encrypts the form data utilizing the encryption key, at operation 508, to generate an encrypted electronic form.

The encrypted electronic form is then submitted, at operation 512, to the form collection destination 170. At operation 514, the notification module 460 may notify the recipient that an encrypted version of the electronic form has been submitted to the form collection destination 170.

It will be noted that, while the operations of the method 500 have been described to be performed in a particular order, in some embodiments, the operations of the method 500 may be performed in a different order or in parallel. For example, the operations of accessing the encryption key and accessing of the form data may be performed in a reverse order or in parallel.

As mentioned above, an original form may be designed to include a control button to permit a user to submit the form to the form collection destination 170 by merely pressing a so-called submit button. In one example embodiment, a secure submit button may be implemented in XFA as shown below.

```
<field>
  <ui>
    <button/>
  </ui>
  <event activity=“click”>
    <submit format=“pdf”
  target=“mailto:forms_collector@company.com”
  textEncoding=“UTF-8”>
    <encrypt>
      <certificate>public key data</certificate>
    </encrypt>
    </submit>
  </event>
</field>
```

In one example embodiment, when a recipient clicks on a secure submit button, a so-called electronic envelope is created in a manner that is transparent to the recipient. The filled-out original form may be added as an encrypted attachment to the electronic envelope. The electronic envelope may then submitted to the form collection destination 170. For the purposes of this description, the term “electronic envelope” will be understood to include a variety of techniques to communicate information over a network.

It will be noted, that a variety of security schemes may be utilized advantageously for delivering electronic documents (e.g., electronic forms). For example, an electronic form may be configured to include a mechanism, such that when a recipient fills out an electronic form and activates a submit control, a password protection may be automatically added to the form and the form be emailed to the originator. A password scheme may be defined by the originator and embedded in the electronic form.

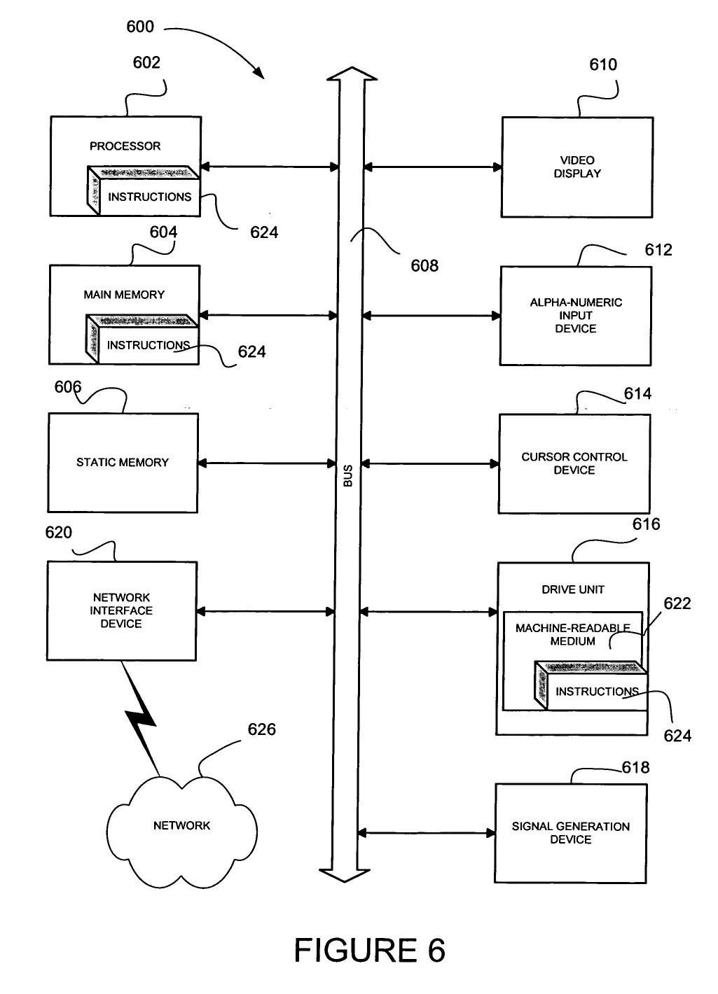

FIG. 6 shows a diagrammatic representation of a machine in the example electronic form of a computer system 600 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system for secure form delivery have been described. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A computer system comprising:
a detector, stored in a memory, to detect a request to submit an electronic form, the electronic form including associated application data;
an encryption module to respond to the request to submit the electronic form by:
automatically accessing an encryption key,
determining destination information, and
encrypting the associated application data, utilizing the encryption key; and
a submit module to submit the electronic form to a destination, utilizing the destination information.

2. The system of claim 1, wherein the electronic form includes the encryption key.

3. The system of claim 1, wherein the electronic form includes the destination information.

4. The system of claim 1, wherein the encryption key is a public key from a key pair, and wherein the key pair is associated with a recipient at the destination.

5. The system of claim 1, wherein the electronic form is a certified electronic form.

6. The system of claim 1, wherein the destination information is associated with an electronic mail address.

7. The system of claim 1, wherein the destination information is associated with a web site.

8. The system of claim 1, further comprising an extractor to extract the encryption key and to save the encryption key separately from the electronic form.

9. The system of claim 1, wherein the request to submit the electronic form is associated with an activation of a control presented to a user via a user interface associated with the electronic form.

10. The system of claim 1, further comprising a notification module to notify an originator of the request to submit the electronic form of an encryption status of the submitted electronic form.

11. The system of claim 1, wherein the electronic form is in a Portable Document Format (PDF).

12. A method comprising:
detecting a request to submit an electronic form, the electronic form including associated application data;
responding to the request to submit the electronic form by:
automatically accessing an encryption key,
determining destination information, and
encrypting the associated application data, utilizing the encryption key; and
submitting the electronic form to a destination, utilizing the destination information.

13. The method of claim 12, wherein the electronic form includes the encryption key.

14. The method of claim 12, wherein the electronic form includes the destination information.

15. The method of claim 12, wherein the encryption key is a public key from a key pair, and wherein the key pair is associated with a recipient at the destination.

16. The method of claim 12, wherein the electronic form is a certified electronic form.

17. The method of claim 12, wherein the destination information is associated with an electronic mail address.

18. The method of claim 12, wherein the destination information is associated with a web site.

19. The method of claim 12, further comprising extracting the encryption key and saving the encryption key separately from the electronic form.

20. The method of claim 12, wherein the request to submit the electronic form is associated with an activation of a control presented to a user via a user interface associated with the electronic form.

21. The method of claim 12, further comprising notifying an originator of the request to submit the electronic form of an encryption status of the submitted electronic form.

22. The method of claim 12, wherein the electronic form is in a Portable Document Format (PDF).

23. A computer system comprising:
a forms creator, stored in memory, to create an electronic form, the electronic form having an encryption module to automatically, without a request to encrypt from a user, encrypt application data associated with the electronic form in response to a triggering event;
a distribution module to distribute the electronic form to at least one recipient to obtain the application data; and
a forms collector to receive the electronic form with the encrypted application data from the recipient.

24. The system of claim 23, further comprising a certification selector to certify the electronic form to be distributed by the distribution module.

25. The system of claim 23, wherein the triggering event comprises a request to submit the electronic form.

26. The system of claim 23, wherein the triggering event comprises a request to save the electronic form.

27. The system of claim 23, wherein the forms creator is to include an encryption key with the electronic form.

28. The system of claim 23, wherein the forms creator is to include destination information with the electronic form, the destination information associated with the forms collector.

29. A method comprising:
creating an electronic form having an encryption module to automatically, without a request to encrypt from a user, encrypt application data associated with the electronic form in response to a triggering event; and
distributing the electronic form to at least one recipient to obtain the application data.

30. The method of claim 29, further comprising receiving the electronic form with the encrypted application data from the recipient.

31. The method of claim 29, further comprising certifying the electronic form to be distributed by the distribution module.

32. The method of claim 29, wherein the triggering event comprises a request to submit the electronic form.

33. The method of claim 29, wherein the triggering event comprises a request to save the electronic form.

34. The method of claim 29, wherein the electronic form comprises an encryption key.

35. The method of claim 29, wherein the electronic form comprises destination information, the destination information being associated with the forms collector.

36. A system comprising:
a detector to detect a request to save application data associated with an electronic form; and
an encryption module to respond to the request by:
automatically accessing an encryption key embedded in the electronic form, and
encrypting the application data associated with the electronic form, utilizing the encryption key.

37. A machine-readable non-transitory storage medium having instruction data to cause a machine to:
detect a request to submit an electronic form, the electronic form comprising associated application data;
respond to the request to submit the electronic form by:
automatically accessing an encryption key,
determining destination information, and
encrypting the associated application data, utilizing the encryption key; and
submit the electronic form to a destination, utilizing the destination information.

38. A system comprising:
means for detecting, by a computer, a request to submit an electronic form, the electronic form comprising associated application data;
means for responding to the request to submit the electronic form by:
automatically accessing an encryption key,
determining destination information, and
encrypting the associated application data, utilizing the encryption key; and
means for submitting the electronic form to a destination, utilizing the destination information.

39. A computer-readable non-transitory storage medium containing a data structure for use in distributing an electronic form, the data structure comprising:
a plurality of fields associated with an electronic form;
an encryption key associated with the electronic form; and
a destination address associated with the electronic form.

40. The computer-readable medium of claim 39, further storing an encryption instruction associated with the encryption key and a triggering event.
